(19) United States
(12) Patent Application Publication
(10) Pub. No.: US 2015/0165405 A1
(43) Pub. Date: Jun. 18, 2015

(54) FIBER MIXING SYSTEM

(71) Applicant: SCHLUMBERGER TECHNOLOGY CORPORATION, Sugar Land, TX (US)

(72) Inventors: Hau Nguyen-Phuc Pham, Houston, TX (US); Edward Kent Leugemors, Needville, TX (US)

(21) Appl. No.: 14/565,146

(22) Filed: Dec. 9, 2014

Related U.S. Application Data
(60) Provisional application No. 61/915,682, filed on Dec. 13, 2013.

(51) Int. Cl. B01F 15/02; E21B 43/26; C09K 8/80; B01F 3/12

(52) U.S. Cl. CPC B01F 15/0283; B01F 3/12; B01F 15/0235; B01F 3/1214; E21B 43/26; C09K 8/80; B01F 2003/1257; B01F 2003/1285; B01F 2015/0221

(57) ABSTRACT

An apparatus comprising a first mixer, a second mixer, and a pump. The first mixer may comprise a first material inlet for receiving a first material, a first fluid inlet for receiving a first fluid, and a first outlet for discharging a first mixture comprising the first material and the first fluid. The second mixer may comprise a second material inlet for receiving a second material, a second fluid inlet for receiving the first mixture from the first outlet, and a second outlet for discharging a second mixture comprising the second material and the first mixture. The pump may comprise a pump inlet for receiving the second mixture at a first pressure and a pump outlet for discharging the second mixture at a second pressure. The second pressure may be substantially greater than the first pressure.

### CROSS-REFERENCE TO RELATED APPLICATIONS

This application claims the benefit of U.S. Provisional Application No. 61/915,682, entitled “FIBER BLENDING AND PUMPING DEVICE FOR FIBER APPLICATIONS IN WELL STIMULATION,” filed Dec. 12, 2013, the entire disclosure of which is hereby incorporated herein by reference.

### BACKGROUND OF THE DISCLOSURE

In hydraulic fracturing operations, fracturing fluid is injected into a wellbore by high pressure fracturing pumps, penetrating a subterranean rock formation and forcing the fracturing fluid at a predetermined fracturing pressure to fracture the rock formation around the wellbore. Proppant and other materials may be included in the fracturing fluid to prevent the closure of fractures after the fracturing pressure is released, thereby facilitating an improved flow of recoverable fluids. The success of the hydraulic fracturing operations may be related to distribution of the proppant and other materials within the fracturing fluid and the fracture. Thus, even when the fracturing fluid is prepared by combining the proppant and other materials at the wellsite, such materials are combined according to precise specifications utilizing highly controlled processes and surface equipment.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces an apparatus that includes a first mixer, a second mixer, and a pump. The first mixer includes a first material inlet for receiving a first material, a first fluid inlet for receiving a first fluid, and a first outlet for discharging a first mixture that includes the first material and the first fluid. The second mixer includes a second material inlet for receiving a second material, a second fluid inlet for receiving the first mixture from the first outlet, and a second outlet for discharging a second mixture that includes the second material and the first mixture. The pump includes a pump inlet for receiving the second mixture at a first pressure and a pump outlet for discharging the second mixture at a second pressure. The second pressure may be substantially greater than the first pressure.

The present disclosure also introduces a method that includes delivering a first material to a first material inlet of a first mixer, delivering a first fluid to a first fluid inlet of the first mixer, and mixing the first material and the first fluid in the first mixer to form a first mixture. The method also includes discharging the first mixture through a first outlet of the first mixer, delivering a second material to a second material inlet of a second mixer, and delivering the first mixture to the second mixer. The method also includes mixing the second material and the first mixture in the second mixer to form a second mixture, and discharging the second mixture through a second outlet of the second mixer.

The present disclosure also introduces an apparatus that includes a hydraulic fracturing system. The hydraulic fracturing system includes a first mixer to mix a hydratable material and an aqueous fluid to form a first fluid, a second mixer fluidly connected with the first mixer to mix a fibrous material and the first fluid to form a first mixture, and a third mixer fluidly connected with the second mixer to mix a proppant material and the first mixture to form a second mixture. The hydraulic fracturing system also includes a pump fluidly connected with the third mixer. The pump is operable to receive the second mixture at a first pressure and discharge the second mixture at a second pressure that may be substantially greater than the first pressure.

These and additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of apparatus according to one or more aspects of the present disclosure.

FIG. 2 is a schematic view of an example implementation of the apparatus shown in FIG. 1 according to one or more aspects of the present disclosure.

FIG. 3 is a schematic side view of a portion of an example implementation of the apparatus shown in FIG. 1 according to one or more aspects of the present disclosure.

FIG. 4 is a sectional side view of a portion of an example implementation of the apparatus shown in FIG. 1 and FIG. 2 according to one or more aspects of the present disclosure.

FIG. 5 is a partial sectional top view of a portion of the apparatus shown in FIG. 4 according to one or more aspects of the present disclosure.

FIG. 6 is an isometric view of a portion of an example implementation of the apparatus shown in FIG. 1 according to one or more aspects of the present disclosure.

FIG. 7 is an isometric view of a portion of an example implementation of the apparatus shown in FIG. 1 according to one or more aspects of the present disclosure.

FIG. 8 is an isometric view of a portion of an example implementation of the apparatus shown in FIG. 1 according to one or more aspects of the present disclosure.

FIG. 9 is a flow-chart diagram of at least a portion of a method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

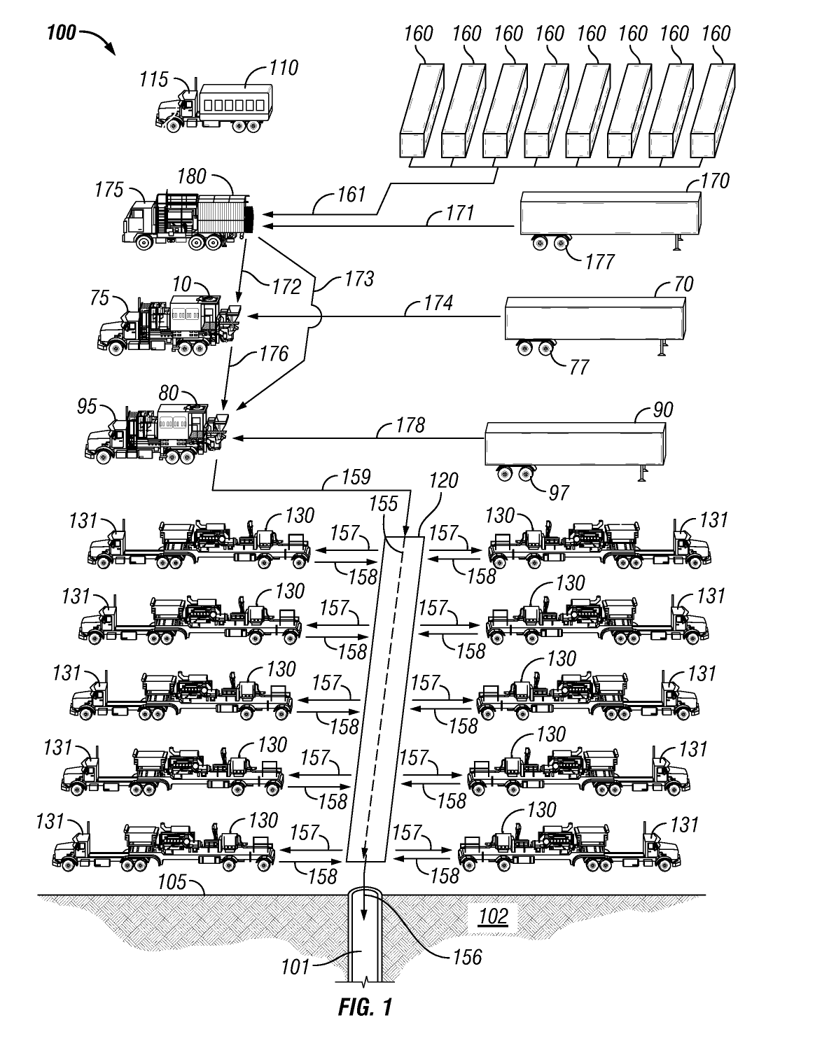

FIG. 1 is a schematic view of at least a portion of a pumping system 100 according to one or more aspects of the present disclosure. The figure depicts a wellsite surface 105 adjacent to a wellbore 101 and a partial sectional view of the subterranean formation 102 below the wellsite surface 105.

The pumping system 100 may comprise a first mixer 180 fluidly connected with one or more tanks 160 and a first container 170. The container 170 may contain a first material and the tank(s) 160 may contain a liquid. The first material may be or comprise a hydratable material or gelling agent, such as guar, a polymer, a synthetic polymer, a galactomannan, a polysaccharide, a cellulose, and/or a clay, among other examples, and the liquid may be or comprise an aqueous fluid, which may comprise water or an aqueous solution comprising water, among other examples. The first mixer 180 may be operable to receive the first material and the liquid, as indicated by arrows 161, 171, and mix or otherwise combine the first material and the liquid to form a base fluid. The base fluid may be or comprise that which is known in the art as a gel. The first mixer 180 may then discharge the base fluid, as indicated by arrows 172, 173.

The first mixer 180 and the first container 170 may each be disposed on corresponding trucks, trailers, and/or other mobile carriers 175, 177, respectively, such as may permit their transportation to the wellsite surface 105. However, the first mixer 180 and/or the first container 170 may be skidded or otherwise stationary, and/or may be temporarily or permanently installed at the wellsite surface 105.

The pumping system 100 may further comprise a second mixer 10 fluidly connected with the first mixer 180 and a second container 70. The second container 70 may contain a second material that may be substantially different than the first material. For example, the second material may be or comprise a fibrous material, such as may comprise a polymer, fiberglass, phenol formaldehyde, polyester, polylactic acid, cedar bark, shredded cane stalks, mineral fiber, and/or hair, among other examples. The fibrous material may comprise a material operable to form a matrix within the base fluid to aid in hydraulic fracturing operations. The second material may also include a dry surfactant, a breaker capable of breaking down polymer chains of the base fluid, and/or other oilfield material. The second mixer 10 may be operable to receive the base fluid from the first mixer 180, as indicated by arrow 172, and the second material from the second container 70, as indicated by arrow 174, and mix or otherwise combine the base fluid and the second material to form another mixture, referred to herein as the first mixture. The second mixer 10 may then discharge the first mixture, as indicated by arrow 176.

The second mixer 10 and the second container 70 may each be disposed on corresponding trucks, trailers, and/or other mobile carriers 75, 77, respectively, such as may permit their transportation to the wellsite surface 105. However, the second mixer 10 and/or the second container 70 may be skidded or otherwise stationary, and/or may be temporarily or permanently installed at the wellsite surface 105.

The second mixer 10 may discharge the first mixture to a third mixer 80, as indicated by arrow 176. The second mixer 10 may produce lower output volumes and/or operate at speeds lower than that of the third mixer 80, such as to avoid overflowing and/or over-pressurizing of the inlet of the third mixer 80. The third mixer 80 may be fluidly connected with the second mixer 10 and/or a third container 90. The third container 90 may contain a third material that may be substantially different than the first and second materials. For example, the third material may be or comprise a proppant material, such as may comprise sand, sand-like particles, silica, quartz, and/or propping agents, among other examples. The third mixer 80 may be operable to receive the first mixture from the second mixer 10, as indicated by arrow 176, and the third material from the third container 90, as indicated by arrow 178, and mix or otherwise combine the first mixture and the third material to form another mixture, referred to herein as the second mixture. The third mixer 80 may also be operable to receive the base fluid from the first mixer 180, as indicated by arrow 173, and mix or otherwise combine the base fluid, the first material, and the third mixture to form another mixture, referred to herein as the third mixture. The third mixer 80 may then discharge the second or third mixture, as indicated by arrow 159.

The third mixer 80 and the third container 90 may each be disposed on corresponding trucks, trailers, and/or other mobile carriers 95, 97, respectively, such as may permit their transportation to the wellsite surface 105. However, the third mixer 80 and/or the third container 90 may be skidded or otherwise stationary, and/or may be temporarily or permanently installed at the wellsite surface 105.

The second or third mixture may be communicated from the third mixer 80 to a common manifold 120, as indicated by arrow 159. The manifold 120 may comprise a plurality of valves, diverters, and/or conduits (not shown) operable to direct the second or third mixture in a predetermined and/or selective manner. The manifold 120 may be known in the art as a missile or a missile trailer. The manifold 120 may distribute the second or third mixture to one or more pumps 130, which may each be or comprise a plunger pump or other pump operable for hydraulic fracturing. Each pump 130 may receive the second or third mixture, as indicated by arrows 157, and discharge the second or third mixture to the manifold 120, as indicated by arrows 158. The manifold 120 may then discharge the second or third mixture into the wellbore 101, as indicated by arrow 156, perhaps through various valves, conduits, and/or other hydraulic circuitry fluidly connected between the manifold 120 and the wellbore 101.

The pumps 130 may each be disposed on corresponding trucks, trailers, and/or other mobile carriers 131, such as may permit their transportation to the wellsite surface 105. However, the pumps 130 may be skidded or otherwise stationary, and/or may be temporarily or permanently installed at the wellsite surface 105.

A control center 110 may be employed to control at least a portion of the pumping system 100 during pumping operations. For example, the control system 110 may be operable to pair the valves of the manifold 120 with the pumps 130 to create an interlock between the pumps 130 and the manifold 120. The control center 110 may also be operable to isolate predetermined pumps 130 from an internal flow pathway 155 of the second or third mixture through the manifold 120. The control center 110 may be further operable to control the production rate of the second or third mixture, such as by increasing or decreasing the flow of the liquid from the tank(s) 160, the first material from the first container 170, the base fluid from the first mixer 180, the second material from the second container 70, the first mixture from the second mixer 10, and/or the second or third material from the third mixer 80.

The control center 110 may be disposed on a corresponding truck, trailer, and/or other mobile carrier 115, such as may permit its transportation to the wellsite surface 105. However, the control center 110 may be skidded or otherwise stationary, and/or may be temporarily or permanently installed at the wellsite surface 105.

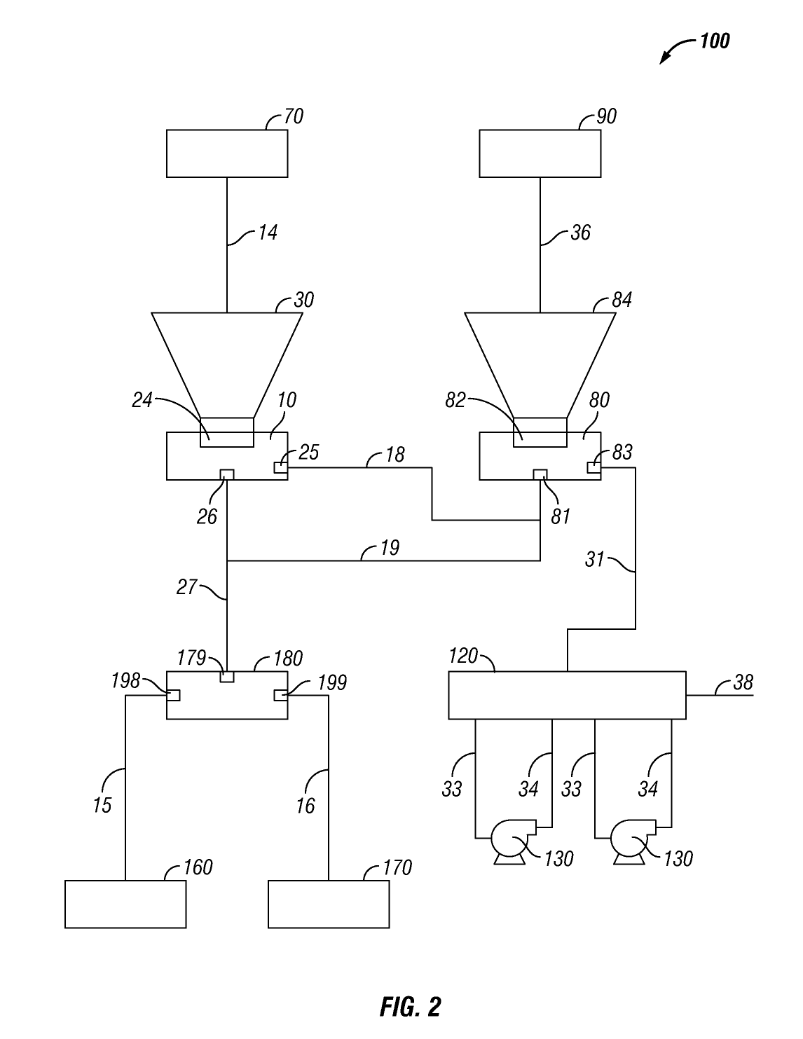

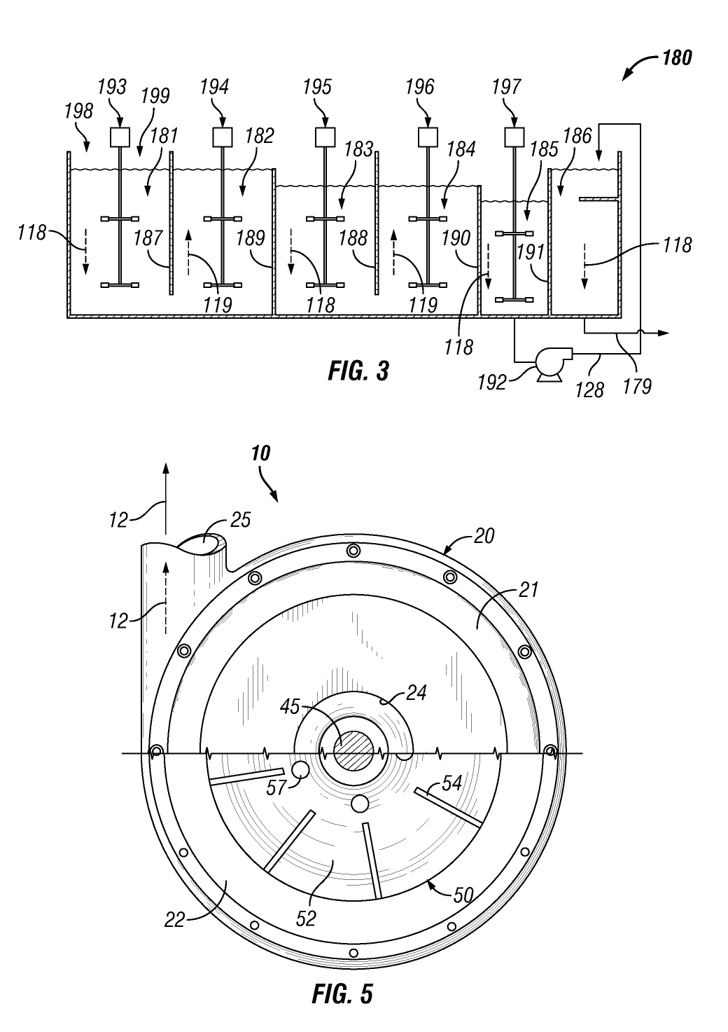

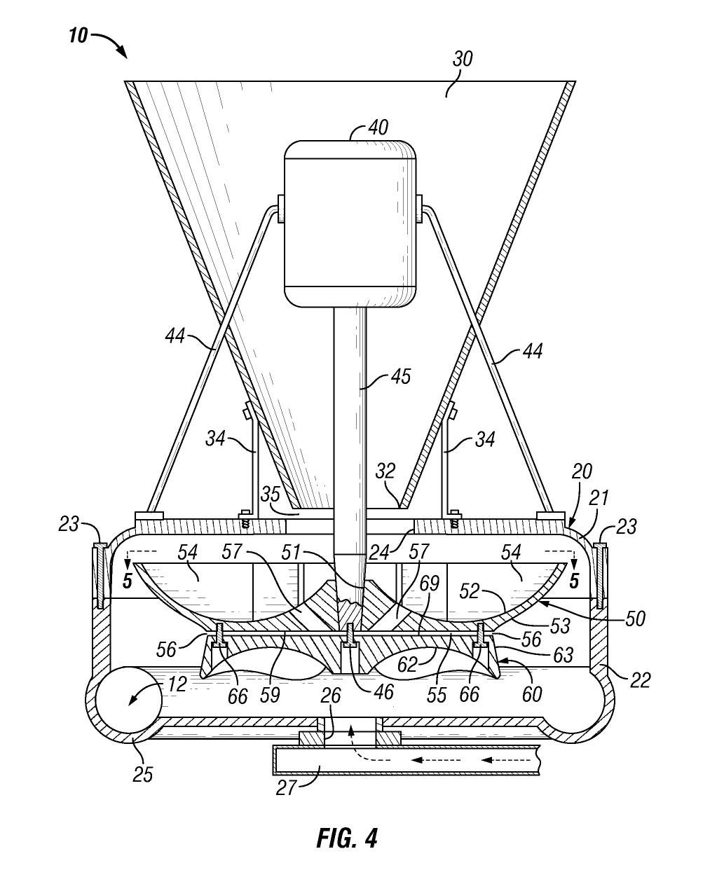

FIG. 2 is a schematic view of an example implementation of the pumping system 100 shown in FIG. 1, such as may facilitate hydraulic fracturing, according to one or more aspects of the present disclosure. Referring to FIGS. 1 and 2, collectively, the first mixer 180 may comprise a first inlet 198 fluidly connected by a fluid conduit 15 with the tank(s) 160 containing the liquid, and a second inlet 199 fluidly connected by a fluid conduit 16 with the first container 170 containing the first material. The first mixer 180 may be or comprise a receptacle, a mixing receptacle, a continuous mixing receptacle (e.g., see FIG. 3), an eductor, a shearing pump, an agitator, a vortex blender (e.g., see FIGS. 4 and 5), and/or other mixing apparatus operable to receive and mix the first material and the liquid to form the base fluid. The first mixer 180 may then discharge the base fluid through an outlet 179.

The second mixer 10 may be fluidly connected by a fluid conduit 27 with the first mixer 180, and may be fluidly connected by a fluid conduit 14 with the second container 70 containing the second material. A first inlet 26 of the second mixer 10 may receive the base fluid from the first mixer 180, and a second inlet 24 of the second mixer 10 may receive the second material from the second container 70. The second mixer 10 may further comprise a hopper 30 or other member operable to hold and/or guide the second material into the second inlet 24, such as in implementations in which the second material is delivered to the second inlet 24 in a particulate, granular, flake, and/or pelletized form. The second mixer 10 may discharge the first mixture through an outlet 25.

The third mixer 80 may be fluidly connected by a fluid conduit 18 with the second mixer 10, and may be fluidly connected by a fluid conduit 19 with the first mixer 180. The third mixer 80 may also be fluidly connected by a fluid conduit 36 with the third container 90 containing the third material, and may also be fluidly connected by a fluid conduit 31 with the manifold 120. A first inlet 81 of the third mixer 80 may receive the first mixture from the second mixer 10 and/or the base fluid from the first mixer 180, and a second inlet 82 of the third mixer 80 may receive the third material from the third container 90. The third mixer 80 may further comprise a hopper 84 or other member operable to hold and/or guide the third material into the second inlet 82. The third mixer 80 may discharge the second or third mixture through an outlet 83.

The second and third materials may be the same or similar materials, such as may allow the same or similar material to be mixed with the base fluid in discrete stages. The first, second, and third materials may be different oilfield materials. The second and third mixtures may each be operable as a fracturing fluid, wherein the first material may increase the viscosity of the fracturing fluid and may facilitate the suspension of the third material therein. The first material may also act as a friction reducing agent to facilitate higher pump rates with substantially less frictional pressure. The second material may form a matrix within the fracturing fluid to facilitate retention of the third material within the fractures formed in the formation 102 around the wellbore 101. The combination of the second and third mixers 10, 80 may facilitate additional control of the fracturing fluid composition, pressure, and flow rate produced by the pumping system 100, and the homogeneity of the second and third materials within the fracturing fluid. The second and third mixers 10, 80 may be positioned and hydraulically connected relative to one another such that the first mixture discharged from the second mixer 10 may remain homogeneous when received by the third mixer 80.

The combination of the second and third mixers 10, 80 may also facilitate a progressive increase in outlet pressures, wherein a second pressure at which the second or third mixture is discharged from the third mixer 80 may be substantially greater than a first pressure at which the first mixture is discharged from the second mixer 10. For example, the first pressure may be less than about half of the second pressure, such as in implementations in which the first pressure ranges between about eight pounds per square inch (PSI) and about ten PSI and the second pressure ranges between about sixteen PSI and about twenty PSI. In another example, the second pressure may range between about fifty PSI and about eighty PSI. However, other operating pressures are also within the scope of the present disclosure.

The fracturing fluid (i.e., the second or third mixture) may be discharged from the outlet 83 of the third mixer 80 at a relatively low pressure and communicated into the manifold 120 through the fluid conduit 31. The manifold 120 may distribute the low pressure fracturing fluid between the one or more pumps 130 via one or more fluid conduits 33. The one or more pumps 130 may discharge the fracturing fluid at a high pressure into the manifold 120 through one or more fluid conduits 34. For example, the fracturing fluid may be discharged from the one or more pumps 130 at a pressure ranging between about 3,000 PSI and about 15,000 PSI, or at other pressures that may facilitate fracturing the formation 102 surrounding the wellbore 105. The manifold 120 may then discharge the fracturing fluid through a fluid conduit 38 into the wellbore 101.

The fluid conduits 14-16, 18, 19, 27, 31, 33, 34, 36, and 38 may each comprise one or more fluid conduits that are known and/or operable in typical wellsite operations. For example, the fluid conduits 14-16, 18, 19, 27, 31, 33, 34, 36, and 38 may each comprise one or more sections of hose, tubing, pipe, and/or other means of suitable sizes and pressure ratings to communicate or otherwise transfer the corresponding liquid, fluid, material, and/or mixture at the called for flow rates, pressures, and/or other operating parameters.

FIG. 3 is a schematic side view of an example implementation of at least a portion of first mixer 180 shown in FIGS. 1 and 2 according to one or more aspects of the present disclosure. The first mixer 180 may be or comprise a continuous mixing receptacle having a first-in-first-out mode of operation. The first mixer 180 may comprise a single space or an open area (not shown), an elongated single space or an elongated open area (not shown), or an elongated space at least partially separated by baffles and/or walls.

For example, the first mixer 180 may comprise a series of tanks 181-186 forming a flow path through the first mixer 180. Each of the tanks 181-186 may have a downward flow path, as indicated by arrows 118, or an upward flow path, as indicated by arrows 119. Thus, for example, the liquid received from the tank(s) 160 and the first material received from the first container 170 may enter the first tank 181 via the inlets 198, 199 and may flow downward through the tank 181, then under a first separator wall 187, and then upward through the next tank 182. In the second tank 182, the upward flow causes the liquid and the first material to pass over a separator 189 and into the next tank 183. In a manner similar to the first and second tanks 181, 182, the liquid and the first material flow downward through the tank 183, then under a second separator wall 188, then upward through the next tank 184, and then over a second separator 190 into the next tank 185. The liquid and the first material then flow downward through the tank 185 and are pumped through a conduit 128 into the final tank 186 by a pump 192. By the time the liquid and the first material reach the tank 186, the liquid and the first material have mixed or otherwise combined to form the base fluid, which flows downward until discharged out of the tank 186 through the outlet 179. The first mixer 180 may further comprise impeller assemblies 193-197, such as may be operable to stir or otherwise agitate the liquid and the first material within the tanks 181-185 and/or encourage the above-described flow directions. The first mixer 180 may comprise a substantially lesser number of tanks, such as between two and five tanks.

FIG. 4 is a sectional side view of at least a portion of an example implementation of the second mixer 10 shown in FIGS. 1 and 2 according to one or more aspects of the present disclosure. As depicted in FIG. 4, the second mixer 10 may be a vortex blender comprising a hopper 30, such as may receive the second material from the second container 70. The second mixer 10 further comprises a casing 20 (i.e., a housing) that may receive the second material from the hopper 30 and the base fluid from the first mixer 180 through conduit 27 and a first inlet 26. The second material and the base fluid may be mixed in the casing 20 to form the first mixture. The casing 20 may comprise an upper section 21 coupled with a lower section 22, whether via one or more threaded fasteners 23 and/or other means.

The hopper 30 may be mounted above the casing 20 by one or more vertical supports 34. The bottom end of the hopper 30 may comprise an outlet opening 32 that terminates at or just above a second inlet 24, such as in a manner permitting the second material to be continuously dropped from the hopper 30 into the casing 20. Disposing the outlet opening 32 of the hopper 30 just above the second inlet 24 may provide an exterior air exhaust space 35 between the hopper 30 and the second inlet 24, such as may allow air or other gasses located between and/or within the second material to vent from the casing 20. However, the ability to vent air or other gasses out of the casing 20 may be provided by other means, such as a vent tube (not shown) that may extend through the wall of the hopper 30 and downward through the second inlet 24. When such venting means are utilized, the hopper 30 may abut against the second inlet 24, such that the exhaust space 35 is minimized or eliminated.

The second mixer 10 may further comprise a drive shaft or another drive extension 45 extending into the casing 20 through the second inlet 24, including extending through the upper section 21 of the casing 20. The drive extension 45 may be driven by a motor or another rotary drive 40 operatively coupled with the drive extension 45. The rotary drive 40 may be maintained in position by one or more supports 44, such as may be fastened to the upper section 21 of the casing 20 and/or to other portions of the mixing apparatus 10.

FIG. 5 is a partial sectional top view of a portion of an implementation of the second mixer 10 shown in FIG. 4 according to one or more aspects of the present disclosure. As depicted in FIGS. 4 and 5, the second mixer 10 may further comprise a slinger 50 and an impeller 60 disposed within the casing 20. An upper surface 52 of the slinger 50 may have a toroidal concave configuration facing the upper section 21 of the casing 20. The concave surface 52 of the slinger 50 may comprise thereon a plurality of upstanding, radially outwardly extending blade members 54. The bottom side of the slinger 50 may comprise a flat or otherwise shaped face 59, which may match a corresponding flat or otherwise shaped face 69 on the upper side of the impeller 60. The slinger 50 may be coupled or otherwise fixedly connected to the impeller 60 to rotate synchronously therewith. The slinger 50 may be connected to the impeller 60 at their faces 59, 69 by one or more threaded fasteners 66 and/or other means. The slinger 50 and the impeller 60 are shown axially spaced apart, such as to define an exhaust space 55 between the face 59 of the slinger 50 and the face 69 of the impeller 60. The exhaust space 55 may be operable to exhaust gas therethrough, and a radially outer portion 56 of the exhaust space 55 may be operable as an air or gas inlet into the exhaust space 55. The slinger 50 may further comprise exhaust channels 57, which may extend diagonally or otherwise through the body of the slinger 50. For example, the exhaust channels 57 may extend between the face 59 and the concave surface 52 of the slinger 50, such as may permit air or gas to communicate from the exhaust space 55 to the space between the slinger 50 and the second inlet 24. The slinger 50 may further comprise an outer side 53 having a radially inward downward sloping surface, which terminates at the gas inlet 56, located at the radially inward portions of the outer side 53.

The impeller 60 may comprise a concave inner surface 62 having a vortex configuration that faces toward the lower section 22 of the casing 20, such that rotation of the impeller 60 may induce air on the underside thereof to move in a vortex manner. An outer side 63 of the impeller 60 may be a radially outward downward sloping surface.

The slinger 50 may further comprise a central opening 51 extending therethrough, such as to receive therein or therethrough the bottom end of the drive extension 45. The impeller 60 may be secured to the bottom end of drive extension 45 by one or more threaded fasteners 46 and/or other means, such as may extend through a central portion of the impeller 60 to threadedly engage the drive extension 45 and retain the impeller 60 in connection with the drive extension 45. As the slinger 50 is coupled with the impeller 60, both the slinger 50 and the impeller 60 may be coupled to the drive extension 45 and, therefore, the rotary drive 40.

The lower section 22 of the casing 20 may comprise an outlet 25 extending therefrom, such as may be operable for discharging the first mixture from the casing 20. The outlet 25 may be positioned adjacent the bottom and radially outward portion of the lower section 22, and may comprise a substantially tubular configuration, whether substantially cylindrical or otherwise. The lower section 22 of the casing 20 may further comprise the first inlet 26 at its axial center. The first inlet 26 may be fluidly connected with the fluid conduit 27, which may be fluidly connected with the outlet 179 of the first mixer 180.

During mixing operations of the second mixer 10, the second material may be mixed with the base fluid to form the first mixture. At the start of the mixing operations, the rotary drive 40 may rotate the drive extension 45 and, therefore, rotate the slinger 50 and the impeller 60. With the slinger 50 and the impeller 60 in motion, a predetermined amount of second material may be loaded into the hopper 30 such that the second material may flow in a substantially continuous stream through the second inlet 24 and drop onto the rotating slinger 50. As the second material drops onto the slinger 50, it is propelled radially outward. With the impeller 60 rotating at the same speed as the slinger 50, the vortex action of the impeller 60 generates a suction force above the first inlet 26, such as may be operable to draw the base fluid from the fluid conduit 27 into the casing 20 though the first inlet 26 and propel the base fluid radially outward.

As the base fluid is pulled into the casing 20, the base fluid is pressurized by the impeller 60 and mixes with the second material. The result is a thorough mixing of the second material and the base fluid to form the first mixture, which may be continuously discharged under pressure through the outlet 25, as shown by arrows 12. During the mixing operations, air trapped within the second material may be carried into the base fluid during the mixing operations. Such trapped air may be exhausted out during the mixing operations from the radially outward portion of the casing 20 to the external atmosphere through the exhaust space 55, the exhaust channels 57, and the second inlet 24. From the outlet 25, the first mixture may be communicated into the third mixer 80.

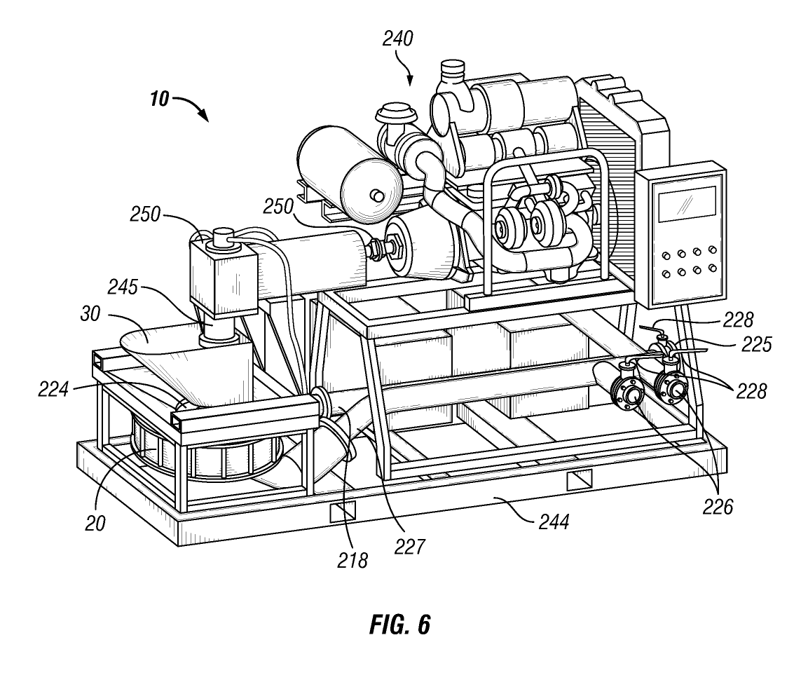

FIG. 6 is a perspective view of at least a portion of an example implementation of the second mixer 10 shown in FIGS. 1 and 2 according to one or more aspects of the present disclosure. The second mixer 10 may be a programmable optimum density (POD) blender comprising a vortex blender design as shown in FIGS. 4 and 5 along with a plurality of fluid control valves 228 and fluid conduits 218, 227 mounted on a skid 244. The second mixer 10 may also include a centrifugal pump, a vortex pump, an impeller pump, and/or other pumps (not numbered) operable to increase the pressure of the discharged first mixture at an outlet 225.

The second mixer 10 is depicted in FIG. 6 as comprising the hopper 30 and the casing 20 shown in FIGS. 4 and 5. The base fluid may be introduced into the casing 20 through one or more inlets 226, which may be fluidly connected to the casing 20 via the fluid conduit 227 shown in FIG. 6 and the fluid conduit 27 and inlet 26 shown in FIG. 4. The second material and the base fluid may be mixed in the casing 20 to form the first mixture. The outlet 225 may be operable for discharging the first mixture from the casing 20, and may be located at the end of the fluid conduit 218, which may be fluidly connected with the casing 20 via the casing outlet 25. The fluid control valves 228 may each be operably coupled with a corresponding one of the outlet 225 and the inlets 226.

FIG. 6 also depicts an implementation of the rotary drive 40 and drive extension 45 shown in FIG. 4, designated in FIG. 6 by reference numerals 240 and 245, respectively, as well as various gearing and/or other motion transmission apparatus 250 operably coupling the rotary drive 240 with the drive extension 245. Certain components of the second mixer 10, such as the casing 20, the rotary drive 240, the drive extension 245, the motion transmission apparatus 250, and/or the fluid conduits 227, 218, may be secured to one or more structural elements of the skid 244, such as to maintain the integrity of the second mixer 10.

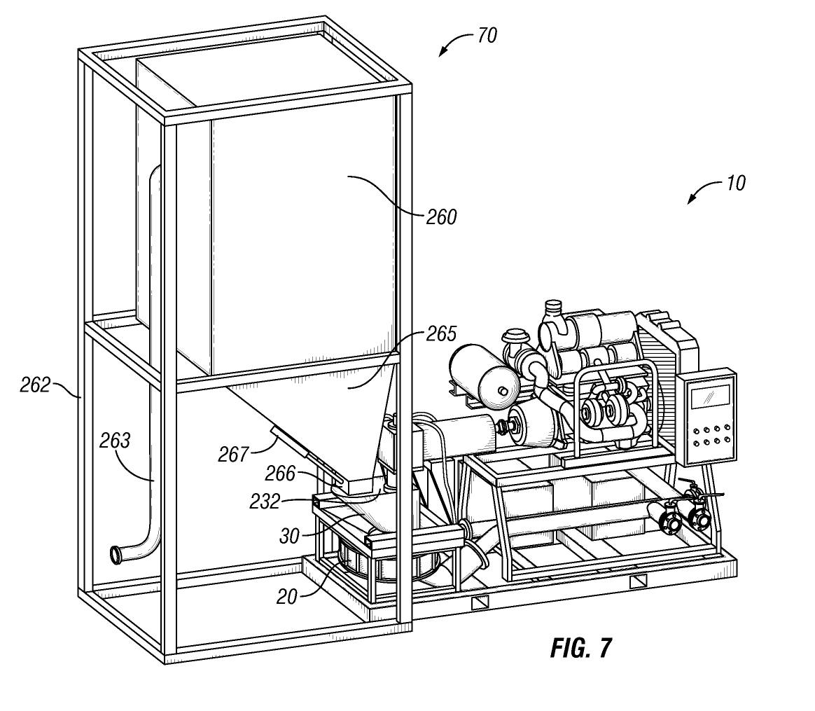

FIG. 7 is a perspective view of at least a portion of an example implementation of the second container 70 and the second mixer 10 shown in FIGS. 1, 2, and 6 according to one or more aspects of the present disclosure. Referring to FIGS. 1, 6, and 7, collectively, the second container 70 may comprise a silo 260 maintained in a predetermined position by a frame 262. A lower portion 265 of the silo 260 may comprise a tapered configuration terminating with a chute 266 disposed generally above the hopper 30 of the second mixer 10. The chute 266 may be opened and closed by an actuator 267. The second material may be fed into the silo 260 through a feeding conduit or other conveyor 263. During mixing operations, the chute 266 may open to allow the second material to be dropped, fed, or otherwise introduced into the hopper 30 and the casing 20, such as for mixing with the base fluid.

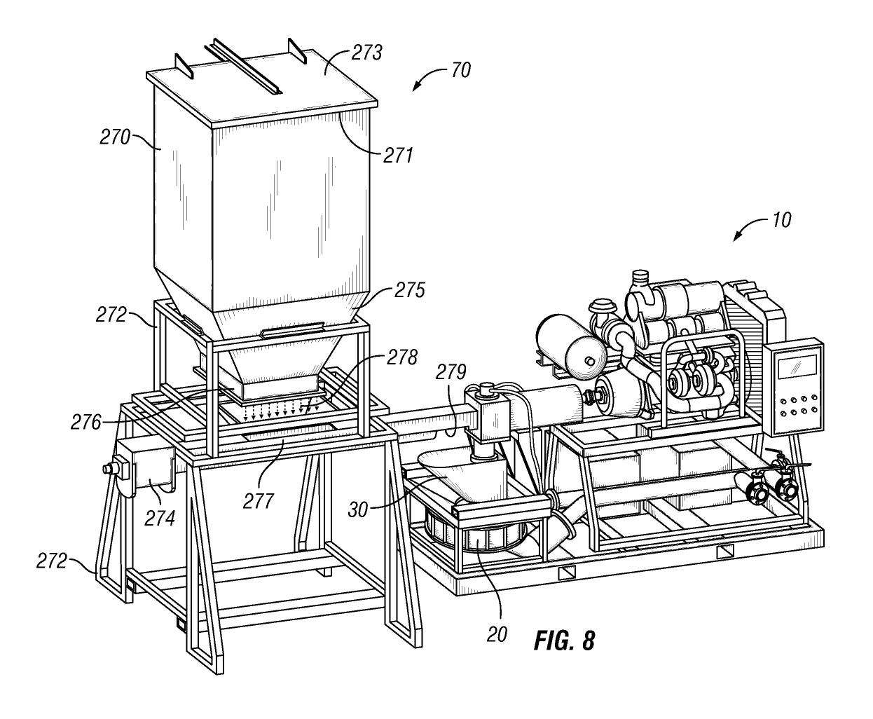

FIG. 8 is a perspective view of a portion of another example implementation of the second container 70 and the second mixer 10 shown in FIGS. 1 and 7 according to one or more aspects of the present disclosure. As depicted in FIG. 8, the second container 70 may comprise a silo 270 maintained in a predetermined position by a framing 272. The second material may be fed into the silo 270 through an upper inlet 271, which may be shut closed by a cover 273. A lower portion 275 of the silo 270 may comprise a tapered configuration terminating with an outlet 276 disposed generally above an inlet 278 of a screw conveyor 277. The screw conveyor 277 may extend toward the second mixer 10 and include an outlet 279 positioned generally above the hopper 30 of the second mixer 10. The screw conveyor 277 may further comprise a screw blade (not shown) extending along the length thereof and operatively coupled with a motor 274, which may be operable to rotate the screw blade. During mixing operations, the rotating screw blade may move the second material from the inlet 278 to the outlet 279. As the outlet 279 may be positioned generally above the hopper 30, the second material may be dropped, fed, or otherwise introduced into the hopper 30 and the casing 20, facilitating the mixing of the second material with the base fluid to produce the first mixture.

Although not depicted in detail, the third container 90 and the third mixer 80 may be implemented similarly as the second container 70 and the second mixer 10 depicted in one or more of FIGS. 4-8 and described above. For example, the third mixer 80 may be a vortex blender comprising the same or similar structure and/or function as the second mixer 10 described above, operable to mix and/or blend the third material, the first mixture, and/or the base fluid. The second and third mixers 10, 80 may also or instead comprise a configuration other than that of a vortex blender. For example, the second and third mixers 10, 80, may include the same or similar structure and/or function as the first mixer 180 described above, including a receptacle, a mixing receptacle, a continuous mixing receptacle (e.g., see FIG. 3), an eductor, a shearing pump, or an agitator, among other examples. The first mixer 180 may also be a vortex blender comprising the same or similar structure and/or function as the second mixer 10 depicted in one or more of FIGS. 4-8 and described above.

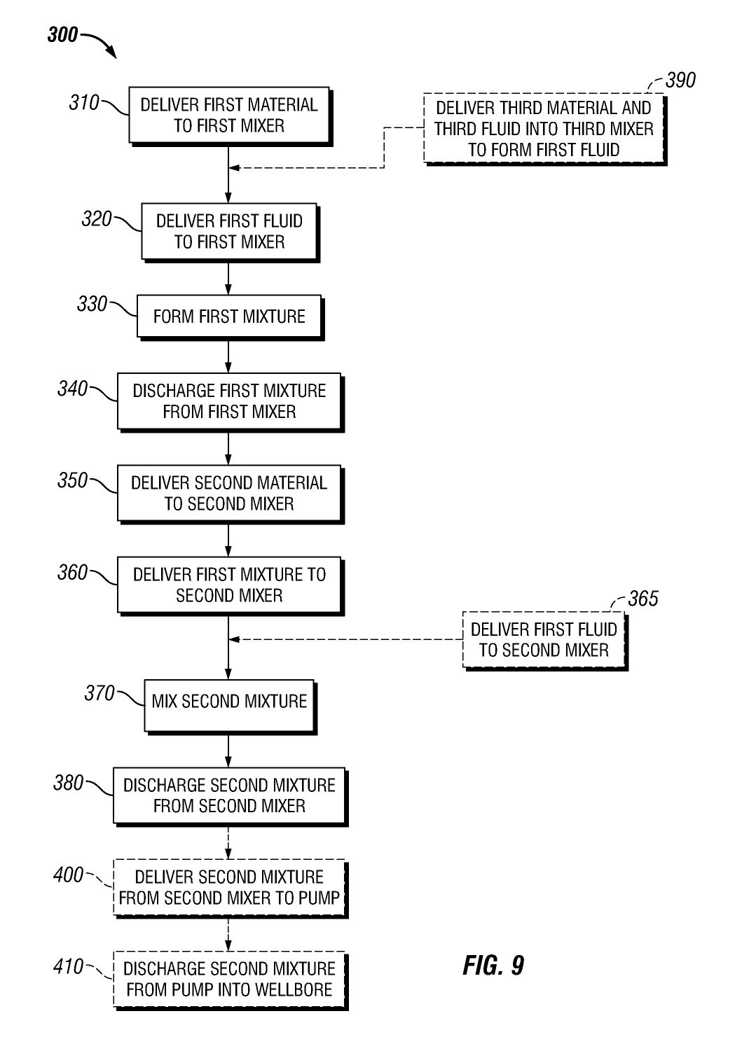

FIG. 9 is a flow-chart diagram of at least a portion of an example implementation of a method (300) according to one or more aspects of the present disclosure. The method (300) may utilize at least a portion of a pumping system, such as the pumping system 100 shown in FIGS. 1 and 2. Thus, the following description refers to FIGS. 1, 2, and 9 collectively. The modifiers “first,” “second,” etc. in the following description, however, differs from those used above.

The method (300) comprises delivering (310) a first material to a first material inlet 24 of a first mixer 10, delivering (320) a first fluid to a first fluid inlet 26 of the first mixer 10, mixing (330) the first material and the first fluid in the first mixer 10 to form a first mixture, and discharging (340) the first mixture through a first outlet 25 of the first mixer 10. The first material may comprise a fibrous material, wherein the fibrous material may comprise a polymer, fiberglass, phenol formaldehyde, polyester, polylactic acid, cedar bark, shredded cane stalks, mineral fiber, and/or hair, among other examples. The fibrous material may also be a particulate, granular, flake, or pelletized material. The first fluid may comprise water and a hydratable material, wherein the hydratable material may comprise guar, a polymer, a synthetic polymer, a galactomannan, a polysaccharide, a cellulose, and/or a clay, among other examples. Delivering (320) the first fluid to the first fluid inlet 26 of the first mixer 10 may comprise delivering the first fluid from a first fluid source 180 to the first fluid inlet 26 of the first mixer 10. The first fluid source may comprise a receptacle, a mixing receptacle, or a continuous mixing receptacle.

The method (300) further comprises delivering (350) a second material to a second material inlet 82 of a second mixer 80, delivering (360) the first mixture to the second mixer 80, mixing (370) the second material and the first mixture in the second mixer 80 to form a second mixture, and discharging (380) the second mixture through a second outlet 83 of the second mixer 80. The second material may comprise sand, sand-like particles, silica, quartz, and/or propping agents, among other examples. Delivering (360) the first mixture to the second mixer 80 may comprise delivering the first mixture to a second fluid inlet 81 of the second mixer 80.

The method (300) may further comprise delivering (365) the first fluid to the second fluid inlet 81 of the second mixer 80. In such implementations, mixing (370) the second material and the first mixture in the second mixer 80 to form the second mixture may comprise mixing the second material, the first mixture, and the first fluid to form the second mixture.

The method (300) may further comprise delivering (390) a third material and a third fluid into a third mixer 180 to form the first fluid. The method (300) may further comprise delivering (400) the second mixture from the second mixer 80 at a first pressure to a pump 130 and discharging (410) the second mixture at a second pressure from the pump 130 into a wellbore 101, wherein the second pressure is substantially greater than the first pressure.

In view of the entirety of the present disclosure, including the figures and the claims, a person having ordinary skill in the art should readily recognize that the present disclosure introduces an apparatus comprising: a first mixer comprising a first material inlet for receiving a first material, a first fluid inlet for receiving a first fluid, and a first outlet for discharging a first mixture comprising the first material and the first fluid; a second mixer comprising a second material inlet for receiving a second material, a second fluid inlet for receiving the first mixture from the first outlet, and a second outlet for discharging a second mixture comprising the second material and the first mixture; and a pump comprising a pump inlet for receiving the second mixture at a first pressure and a pump outlet for discharging the second mixture at a second pressure, wherein the second pressure may be substantially greater than the first pressure.

The apparatus may further comprise a first fluid source, the first and second fluid inlets may be fluidly connected with the first fluid source, the second mixer may be further operable to: receive the first fluid through the second fluid inlet; mix the first fluid, the second material, and the first mixture to form a third mixture; and discharge the third mixture through the second outlet. The pump may be further operable to: receive the third mixture through the pump inlet at the first pressure; and discharge the third mixture through the pump outlet at the second pressure, wherein the second pressure may be substantially greater than the first pressure.

The first material may comprise a fibrous material. The fibrous material may comprise a polymer, fiberglass, phenol formaldehyde, polyester, polylactic acid, cedar bark, shredded cane stalks, mineral fiber, and/or hair. The fibrous material may comprise particulate, granular, flake, and/or pelletized material. The second material may comprise sand, sand-like particles, silica, quartz, and/or propping agents. The first fluid may further comprise a hydratable material comprising guar, a polymer, a synthetic polymer, a galactomannan, a polysaccharide, a cellulose, and/or a clay.

The apparatus may further comprise a first fluid source comprising a receptacle, a mixing receptacle, or a continuous mixing receptacle.

The apparatus may further comprise a first fluid source comprising a third mixer, wherein the third mixer may be operable to: receive therein a hydratable material and an aqueous fluid comprising water; and mix the hydratable material and the aqueous fluid to form the first fluid.

The first mixer may further comprise: a first casing; a first hopper for delivering the first material into the first casing; a first rotary drive disposed external to the first casing; a first slinger suspended for rotation within the first casing via a first drive extension extending from the first rotary drive into the first casing; and a first impeller coupled with the first slinger within the first casing. In such implementations, among others, the second mixer may further comprise: a second casing; a second hopper for delivering the second material into the second casing; a second rotary drive disposed external to the second casing; a second slinger suspended for rotation within the second casing via a second drive extension extending from the second rotary drive into the second casing; and a second impeller coupled with the second slinger within the second casing.

The present disclosure also introduces a method comprising: delivering a first material to a first material inlet of a first mixer; delivering a first fluid to a first fluid inlet of the first mixer; mixing the first material and the first fluid in the first mixer to form a first mixture; discharging the first mixture through a first outlet of the first mixer; delivering a second material to a second material inlet of a second mixer; delivering the first mixture to the second mixer; mixing the second material and the first mixture in the second mixer to form a second mixture; and discharging the second mixture through a second outlet of the second mixer.

Delivering the first mixture to the second mixer may comprise delivering the first mixture to a second fluid inlet of the second mixer.

Delivering the first fluid to the first fluid inlet of the first mixer may comprise delivering the first fluid from a first fluid source to the first fluid inlet of the first mixer.

The method may further comprise delivering the first fluid to the second fluid inlet of the second mixer, wherein mixing the second material and the first mixture in the second mixer to form the second mixture may comprise mixing the second material, the first mixture, and the first fluid to form the second mixture.

The first material may comprise a fibrous material. The fibrous material may comprise a polymer, fiberglass, phenol formaldehyde, polyester, polylactic acid, cedar bark, shredded cane stalks, mineral fiber, and/or hair. The fibrous material may be particulate, granular, flake, or pelletized material. The second material may comprise sand, sand-like particles, silica, quartz, and/or propping agents. The first fluid may comprise water and a hydratable material, wherein the hydratable material may comprise guar, a polymer, a synthetic polymer, a galactomannan, a polysaccharide, a cellulose, and/or a clay.

The first fluid source may comprise a receptacle, a mixing receptacle, or a continuous mixing receptacle.

The method may further comprise delivering a third material and a third fluid into a third mixer to form the first fluid.

The method may further comprise: delivering the second mixture from the second mixer at a first pressure to a pump; and discharging the second mixture at a second pressure from the pump into a wellbore, wherein the second pressure may be substantially greater than the first pressure.

The present disclosure also introduces an apparatus comprising: a hydraulic fracturing system comprising: a first mixer operable to mix a hydratable material and an aqueous fluid to form a first fluid; a second mixer fluidly connected with the first mixer and operable to mix a fibrous material and the first fluid to form a first mixture; a third mixer fluidly connected with the second mixer and operable to mix a proppant material and the first mixture to form a second mixture; and a pump fluidly connected with the third mixer and operable to: receive the second mixture at a first pressure; and discharge the second mixture at a second pressure that may be substantially greater than the first pressure.

The third mixer may be fluidly connected with the first mixer, and the third mixer may be operable to: receive the first fluid therein; and mix the first fluid, the fibrous material, and the first mixture to form a third mixture. The pump may be operable to: receive the third mixture at the first pressure; and discharge the third mixture at the second pressure that may be substantially greater than the first pressure.

The fibrous material may comprise a polymer, fiberglass, phenol formaldehyde, polyester, polylactic acid, cedar bark, shredded cane stalks, mineral fiber, and/or hair. The fibrous material may be delivered into the second mixer in a particulate, granular, flake, and/or pelletized form. The proppant material may comprise sand, sand-like particles, silica, quartz, and/or propping agents. The hydratable material may comprise guar, a polymer, a synthetic polymer, a galactomannan, a polysaccharide, a cellulose, and/or a clay.

The first mixer may comprise a receptacle, a mixing receptacle, or a continuous mixing receptacle.

The second mixer may comprise: a first casing; a first hopper for delivering the fibrous material into the first casing; a first rotary drive disposed external to the first casing; a first slinger suspended for rotation within the first casing via a first drive extension extending from the first rotary drive into the first casing; and a first impeller coupled with the first slinger within the first casing. In such implementations, among others, the third mixer may comprise: a second casing; a second hopper for delivering the proppant material into the second casing; a second rotary drive disposed external to the second casing; a second slinger suspended for rotation within the second casing via a second drive extension extending from the second rotary drive into the second casing; and a first impeller coupled with the second slinger within the second casing.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same purposes and/or achieving the same advantages of the embodiments introduced herein. A person having ordinary skill in the art should also realize that such equivalent constructions do not depart from the scope of the present disclosure, and that they may make various changes, substitutions and alterations herein without departing from the spirit and scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. An apparatus, comprising:
a first mixer comprising a first material inlet for receiving a first material, a first fluid inlet for receiving a first fluid, and a first outlet for discharging a first mixture comprising the first material and the first fluid;
a second mixer comprising a second material inlet for receiving a second material, a second fluid inlet for receiving the first mixture from the first outlet, and a second outlet for discharging a second mixture comprising the second material and the first mixture; and
a pump comprising a pump inlet for receiving the second mixture at a first pressure and a pump outlet for discharging the second mixture at a second pressure, wherein the second pressure is substantially greater than the first pressure.

2. The apparatus of claim 1 further comprising a first fluid source, wherein the first and second fluid inlets are fluidly connected with the first fluid source, wherein:
the second mixer is further operable to:
receive the first fluid through the second fluid inlet;
mix the first fluid, the second material, and the first mixture to form a third mixture; and
discharge the third mixture through the second outlet; and
the pump is further operable to:
receive the third mixture through the pump inlet at the first pressure; and
discharge the third mixture through the pump outlet at the second pressure, wherein the second pressure is substantially greater than the first pressure.

3. The apparatus of claim 1 wherein the first material comprises a fibrous material.

4. The apparatus of claim 3 wherein the fibrous material comprises a polymer, fiberglass, phenol formaldehyde, polyester, polylactic acid, cedar bark, shredded cane stalks, mineral fiber, and/or hair.

5. The apparatus of claim 3 wherein the fibrous material comprises particulate, granular, flake, and/or pelletized material.

6. The apparatus of claim 1 wherein the second material comprises sand, sand-like particles, silica, quartz, and/or propping agents.

7. The apparatus of claim 1 wherein the first fluid further comprises a hydratable material comprising guar, a polymer, a synthetic polymer, a galactomannan, a polysaccharide, a cellulose, and/or a clay.

8. The apparatus of claim 1 further comprising a first fluid source comprising a third mixer, wherein the third mixer is operable to:
receive therein a hydratable material and an aqueous fluid comprising water; and
mix the hydratable material and the aqueous fluid to form the first fluid.

9. The apparatus of claim 1 wherein:
the first mixer further comprises:
a first casing;
a first hopper for delivering the first material into the first casing;
a first rotary drive disposed external to the first casing;
a first slinger suspended for rotation within the first casing via a first drive extension extending from the first rotary drive into the first casing; and
a first impeller coupled with the first slinger within the first casing; and
the second mixer further comprises:
a second casing;
a second hopper for delivering the second material into the second casing;
a second rotary drive disposed external to the second casing;
a second slinger suspended for rotation within the second casing via a second drive extension extending from the second rotary drive into the second casing; and
a second impeller coupled with the second slinger within the second casing.

10. A method, comprising:
delivering a first material to a first material inlet of a first mixer;
delivering a first fluid to a first fluid inlet of the first mixer;
mixing the first material and the first fluid in the first mixer to form a first mixture;
discharging the first mixture through a first outlet of the first mixer;
delivering a second material to a second material inlet of a second mixer;
delivering the first mixture to the second mixer;
mixing the second material and the first mixture in the second mixer to form a second mixture; and
discharging the second mixture through a second outlet of the second mixer.

11. The method of claim 10 wherein delivering the first fluid to the first fluid inlet of the first mixer comprises delivering the first fluid from a first fluid source to the first fluid inlet of the first mixer.

12. The method of claim 10 further comprising delivering the first fluid to the second fluid inlet of the second mixer, wherein mixing the second material and the first mixture in the second mixer to form the second mixture comprises mixing the second material, the first mixture, and the first fluid to form the second mixture.

13. The apparatus of claim 10 wherein the first material comprises a fibrous material.

14. The method of claim 10 wherein the second material comprises sand, sand-like particles, silica, quartz, and/or propping agents.

15. The method of claim 10 wherein the first fluid comprises water and a hydratable material, wherein the hydratable material comprises guar, a polymer, a synthetic polymer, a galactomannan, a polysaccharide, a cellulose, and/or a clay.

16. The method of claim 10 further comprising delivering a third material and a third fluid into a third mixer to form the first fluid.

17. The method of claim 10 further comprising:
delivering the second mixture from the second mixer at a first pressure to a pump; and
discharging the second mixture at a second pressure from the pump into a wellbore, wherein the second pressure is substantially greater than the first pressure.

18. An apparatus, comprising:
a hydraulic fracturing system comprising:
a first mixer operable to mix a hydratable material and an aqueous fluid to form a first fluid;
a second mixer fluidly connected with the first mixer and operable to mix a fibrous material and the first fluid to form a first mixture;
a third mixer fluidly connected with the second mixer and operable to mix a proppant material and the first mixture to form a second mixture; and
a pump fluidly connected with the third mixer and operable to:
receive the second mixture at a first pressure; and
discharge the second mixture at a second pressure that is substantially greater than the first pressure.

19. The apparatus of claim 18 wherein:
the third mixer is fluidly connected with the first mixer;
the third mixer is operable to:
receive the first fluid therein; and
mix the first fluid, the fibrous material, and the first mixture to form a third mixture; and
the pump is operable to:
receive the third mixture at the first pressure; and
discharge the third mixture at the second pressure that is substantially greater than the first pressure.

20. The apparatus of claim 18 wherein:
the fibrous material comprises a polymer, fiberglass, phenol formaldehyde, polyester, polylactic acid, cedar bark, shredded cane stalks, mineral fiber, and/or hair;
the proppant material comprises sand, sand-like particles, silica, quartz, and/or propping agents; and
the hydratable material comprises guar, a polymer, a synthetic polymer, a galactomannan, a polysaccharide, a cellulose, and/or a clay.
